(19) United States
(12) Patent Application Publication
(10) Pub. No.: US 2024/0124960 A1
(43) Pub. Date: Apr. 18, 2024

(54) Cast Iron Material, Use of a Cast Iron Material and Method Manufacturing And/or Lining a Forming Tool

(71) Applicant: Siempelkamp Maschinen- und Anlagenbau GmbH, Krefeld (DE)

(72) Inventors: Jens Stellmacher, Krefeld (DE); Georg Geier, Krefeld (DE)

(21) Appl. No.: 18/278,106

(22) PCT Filed: Feb. 22, 2022
(86) PCT No.: PCT/EP2022/054349

§ 371 Date: Aug. 21, 2023

(30) Foreign Application Priority Data
Feb. 22, 2021 (DE) 10 2021 000 922.3

(51) Int. Cl. C22C 37/08; B29C 33/38; B29C 43/36; C22C 37/04

(52) U.S. Cl. CPC C22C 37/08; B29C 33/38; B29C 43/36; C22C 37/04; B29K 2905/12

(57) ABSTRACT

A cast iron material and methods for using same are disclosed, as well as a method for producing and/or lining a mould. The cast iron material has a change in length at temperatures of −60° C. to 440° C., more particularly in the temperature range from 0° C. to 420° C., which change in length is as small as possible or as similar as possible to that of carbon fibre reinforced polymer or glass-fibre reinforced plastic. The cast iron material has at least the following proportions in percent by weight as elements or as compounds of carbon in the range from approximately 1.5% to 4.0%, silicon in the range from approximately 1.0% to 5.0%, manganese in the range from approximately 0.1% to 1.5%, nickel in the range from approximately 36.5% to 48.0%, chrome in the range from approximately 0.01 to 0.25%, phosphorus to approximately 0.08%, copper to approximately 0.5%, magnesium to approximately 0.150%, the remainder being iron and unavoidable impurities.

### CROSS-REFERENCE TO RELATED APPLICATIONS

This application is the United States national phase of International Application No. PCT/EP2022/054349 filed Feb. 22, 2022, and claims priority to German Patent Application No. 10 2021 000 922.3 filed Feb. 22, 2021, the disclosures of which are hereby incorporated by reference in their entireties.

### BACKGROUND OF THE INVENTION

### Field of the Invention

The invention relates to a cast iron material.

The invention further relates to the use of a cast iron material.

The invention relates to a cast iron material. The cast iron material is highly temperature-invariant and is particularly suitable for temperature-controlled processes, for example for lining a continuously or discretely operating press, a grinding device, a fitting and/or similar devices. The term “cast iron material” can refer to a cast or castable ferrous material; “casting” can therefore be understood as a reference to the original moulding process, “casting”.

### Description of Related Art

DE 10 2011 051 446 A1 describes a cast iron material, which is highly temperature resistant, and generally appears suitable for lining a continuous or discretely operating press, wherein the cast iron material disclosed there prevents carbide formation through high silicon content, and therefore decay annealing is not necessary. Niobium is added as a replacement for part of the molybdenum.

However, this cast iron material, which is generally advantageously designed and can be used in practice for many applications, exhibits the disadvantage that this cast iron material undergoes a length change as the temperature increases. This means that the shrinkage dimensions resulting from cooling to room temperature must already be taken into account in the design, which is inconvenient or even practically impossible in some cases in terms of process technology due to the fact that, among other things, the shrinkage dimensions depend not only on the component geometry and the material properties, but can also vary due to slight deviations in the composition and/or environmental influences during cooling, such as the climatic conditions prevailing in the environment.

This is in particular problematic when designing large cast parts, as different wall thicknesses can hardly be prevented here and cooling rates can vary in areas depending on the wall thickness. Large cast parts also have correspondingly large effective lever lengths. A distortion of a few tenths of a degree can be clearly more disturbing in a large cast part of over 3 m, 5 m or even over 10 m in length, for example, than in a normal cast part, which can range between a few centimetres up to a maximum of around 1.0 m, 1.5 m or 2 m, depending on the opinion and different literature references.

A large cast part can therefore very easily contribute to the warping of the mould and to damage of the casting, moulded piece or compressed part and increase the reject rate or the post-processing effort or even make a single-piece casting impossible due to the occurrence of cracks from arising residual stresses.

The greater the maximum length(s) of a cast workpiece, the greater the problem.

In addition, these problems reoccur in temperature-controlled processes in each process cycle and are not limited to the production process itself.

A further problem arises if the large casting is a press part, in particular a pressing tool, and the press or the pressing tool must be able to be used to manufacture composites with carbon or glass fibre parts.

This is because composites with carbon fibre components, in particular thermoplastics with embedded carbon fibre meshes, e.g. CFRP themselves have extremely low length or volume expansions, wherein in some cases there are strong differences in the direction of the fibre layer or at an angle thereto, in particular orthogonally thereto, which also applies to glass fibre plastics in a significantly weakened form.

In return, such composites, in particular during their thermal manufacturing or processing process, can accordingly hardly withstand a forced expansion. In particular, if so-called “prepregs” or “organo sheets” are to be processed in a temperature-controlled processing process, the length expansion of the pressing tools or the pressing dies can easily represent the decisive limit of the processing possibilities. For this reason, many CFRP components are still cast in so-called RTM processes instead of being pressed out of prepregs, even if this often entails major disadvantages, for example in terms of achievable homogeneity and quality. For example, if only one pressing tool or die part experiences a length or volume change, which differs from the length or volume change of the prepregs or organo sheets or generally of the workpiece to be produced or machined, at least carrier layer portions undergo displacements at least in areas, internally or reaching up to a surface and as a result often at least structural portions also break and can therefore no longer maintain the planned structural strength.

The object of the invention is to develop a cast iron material for the manufacture and/or lining of a mould, a pressing tool or a press which has the smallest possible length and/or volume expansion. This applies in particular to the temperature range from −60° C. to 440° C., in particular from 0° C. to 420° C.

A further object of the invention can be that workpieces produced in a tool mould manufactured from the alloy or lined therewith can be easily detached, in particular to minimise, in particular prevent mutual shrinking in the cooling process before removing the workpiece to be produced.

### SUMMARY OF THE INVENTION

The object is achieved by a cast iron material which comprises at least the following proportions in percentage by weight as elements or as compounds of:
Carbon in the range of approx. 1.0% to 4.0%,
Silicon in the range of approx. 1.0% to 5.0%,
Manganese in the range of approx. 0.1% to 1.5%,
Nickel in the range of approx. 36.5% to 48.0%,
Chromium in the range of approx. 0.01% to 0.25%,
Magnesium up to approx. 0.15%
Copper up to approx. 0.5%,
Phosphorus up to approx. 0.08%,
   with the remainder being iron and unavoidable impurities.

This has the advantage that the cast iron material is cooled from the austenitic crystal lattice and, in the temperature range from −60° C. to 440° C., in particular in the temperature range from 0° C. to 420° C., has an extremely small volume and length change (in the positive direction: volume or length expansion).

Furthermore, it is advantageous that the volume change behaviour of such a cast iron material is largely in line with that of CFRP materials at least within the stated temperature ranges. In addition, the thermal conductivity of a cast iron material is significantly better than that of cast steel due to the precipitated carbon in the form of graphite, such that a more favourable behaviour of the component is achieved in the thermal process.

It is thereby particularly advantageous that the volume change behaviour of such a cast iron material is very similar to that of a GRP material and in particular to that of a CFRP material. Surprisingly, this applies not only to the absolute value in relation to a temperature difference to be overcome, for example specified by a process, but rather, completely differently to alloys of other application areas manufactured for comparable purposes, also applies to the entire course of the length and/or volume change. This is the only way to achieve the goal of minimising or preventing microscopic or macroscopic displacements within the forming workpiece structure.

In addition, the alloy as a cast iron material has significant advantages over a cast steel material alloy: Due to the precipitation of the dissolved carbon from the melt during the solidification process, a composite material is ultimately formed with the cast iron. This precipitation process, which is associated with a volume change in the material, has a favourable effect on the shrinkage behaviour of the cast iron compared to the cast steel. This then leads to a lower shrinkage behaviour, which ultimately also leads to lower shrinkage cavity formation and the existence of a significantly more definite behaviour in itself—especially with regard to the progression of the length or volume change behaviour under temperature influence. In addition, components to be produced therefrom can be produced more easily in solid quality in terms of process technology, which ultimately also has an economic advantage. At the same time, no further heat treatment is often necessary, quite in contrast to cast steel, which is regularly subjected to a heat treatment following the original solidification process.

In addition to the elements listed, the cast iron material can contain impurities in the range from approx. 0.0% to 5.0%, preferably 0.0% to 1.0%, quite preferably 0.0% to 0.5%. The “listed” elements refer to the specifically used alloy components mentioned in the claims which are therefore not to be regarded as “impurities”. When scrap is recycled, other materials are incorporated that lead to the occurrence of further elements, e.g. sodium, potassium, strontium and other elements of the periodic table. Impurities occur as a result, while the main properties are largely retained. Such impurities are therefore also referred to as “inevitable” or “unavoidable” impurities.

In a further embodiment, the above-mentioned cast iron material has a proportion of carbon in the range of approx. 1.0% to 4.0%, preferably of approx. 1.0% to 2.5%, particularly preferably of approx. 1.3% to 2.0%.

This has the advantage that, on the one hand, reactive substances do not react so quickly with the carbon and thus enable easier detachment of the casting from the pressing tool made of the above-mentioned cast iron material. This is particularly advantageous if the cast iron material is to be used for the manufacture of pressing tools and/or pressing dies, since, for example, the resin of the CFRP or GRP is one of the reactive substances in the above-mentioned sense. Furthermore, a carbon proportion in a range mentioned above changes the electronegativity, which contributes to an improvement in the corrosion behaviour of the component produced using the present alloy, in particular a pressing tool or a pressing die, and thus significantly increases, among other things, its economic usability in operation.

Alternatively, it can be provided that the proportion of carbon is in the range of approx. 2.0% to 4.0%, preferably of approx. 2.06% to 4.0%, particularly preferably of approx. 2.2% to 4.0%. Higher carbon proportions, for example, lead to particularly good castability.

In a further embodiment, the above-mentioned cast iron material has a proportion of nickel in the range of approx. 36.5% to 48.0%, preferably of approx. 37.0% to 45%, particularly preferably of approx. 37.5% to 43.0%, even more preferably of approx. 40.1% to 43.0%.

This has the advantage that the cast iron material remains in the austenitic crystal lattice even during slow solidification and does not merge into a cubically body-centred crystal lattice. Furthermore, the cast iron material is paramagnetic. The crystal lattice is slightly pre-stretched magnetically in volume. As the temperature increases, the magnetism decreases and the internal length change increases. However, since the crystal lattice is pre-stretched, both effects cancel each other out with regard to an external length change such that there is no length change outwards. This means that only extremely small length changes of the cast iron material occur below the Curie temperature.

The existing cast iron material is therefore adapted in its crystal structure for defined processes that pass through defined temperature ranges in such manner that the magneto-restriction in the desired temperature range has an optimal effect with regard to length and/or volume expansion.

Castings made of the cast iron material, e.g. an upper tool and lower tool of a press, do not change the length expansion in the range from 0 to 420° C. For the manufacture of CFRP or GRP components, this enables the resin to cure to below 400° C. and then cool down without any disturbing distortion of the compressed part due to the dimensional stability of the pressing tool.

In a further embodiment, the above-mentioned cast iron material has a proportion of magnesium in the range of approx. 0.020% to 0.150%, preferably of approx. 0.040% to 0.100%, particularly preferably of approx. 0.065 to 0.090%.

This has the advantage that sulphur is bound and crystal germs are present for the formation of spheroidal graphite.

In a further embodiment, the above-mentioned cast iron material has a proportion of silicon in the range of approx. 1.0 to 5.0%, preferably of approx. 1.1 to 5.0%, particularly preferably of approx. 1.15 to 5.0%, even more preferably of approx. 1.3 to 5.0%.

This has the advantage that a favourable microstructure is achievable. In side effects, good strength and toughness properties as well as sufficient oxidation resistance can thereby also be achieved.

In a further embodiment, the above-mentioned cast iron material can have a proportion of niobium which is less than 0.33%, in particular less than 0.22%, quite in particular less than 0.11%.

Although the prior art teaches the provision of niobium for achieving good temperature resistance of components which are subject to temperature-controlled processes and can therefore also have a fundamentally positive effect in connection with the manufacture of pressing tools, their linings and/or pressing dies if the pressing tools are to be used in connection with temperature-controlled pressing processes, such as for example the production and/or processing of CFRP components. Surprisingly, however, it was found that niobium interferes with the comparative weighting of the phenomena described above and is also suitable in small quantities for negatively influencing the temperature expansion behaviour of the alloys present here instead of, as assumed, shifting expected (length or volume expansion) curves to a higher temperature range.

In one embodiment, the above-mentioned cast iron material is used for the casting, which results from the cast iron material, to be used for the manufacture and/or lining of a forming tool or pressing tool.

In a further embodiment, the above-mentioned cast iron material is used for the cast iron material to be used as material for an upper pressing tool and lower pressing tool in a press, wherein the pressing tool is operated in continuous or discrete operation.

The cast iron material of the above manufacture and/or embodiments is preferably used for lining a pressing tool such that the cast iron material is in direct contact with the workpiece. During manufacture, it is particularly advantageous that the corresponding component, for example the pressing tool, the lining and/or the die can be manufactured in this way in one piece from the cast iron material.

The cast iron material according to the invention is particularly preferably suitable for the manufacture of thick-walled, larger castings which serve as moulds for the manufacture of products made of glass fibre plastic (GRP) or carbon fibre plastic (CFRP). The present invention refers to larger castings if at least one length of the casting workpiece exceeds 3000 mm, in particular at least 5000 mm, quite in particular at least 8000 mm, or even at least 11500 mm and/or the casting workpiece weighs at least 0.5 t, in particular at least 0.75 t, quite in particular at least 1.25 t or even at least more than 2 t, more than 5 t or more than 8 t. As part of the invention, large cast parts with a maximum wall thickness of more than 100 mm, preferably more than 200 mm, particularly preferably more than 300 mm can therefore be produced, wherein the castings can absorb high forces.

Surprisingly, the cast iron material according to the invention even enables castings manufactured from the cast iron material in one piece to allow for a maximum wall thickness ratio of more than 1.41, in the case of Ni proportions of at least 37.5% even more than 1.51 and, quite particularly surprisingly, in the case of Ni proportions of more than 39.25% even more than 1.65, without substantially losing the advantages of the adaptable volume change behaviour moving into the mentioned regions. This is all the more surprising as it has been assumed to date that the manufacture of cast iron materials above 36.0% Ni proportions would no longer offer any further advantages, but on the contrary would not only be unnecessarily expensive, but would also entail considerable disadvantages. Thus, in the prior art, it has been assumed to date that an Ni proportion above 36.0% would fundamentally prevent the formation of a cast iron material structure, among other things.

The products made of resin and glass fibre mats or carbon fibre mats manufactured in such, in particular one-piece, pressing tools are largely free of fibre breaks by achieving these properties of the pressing tools (or their linings and/or their dies), which are due to a warping of the castings or moulds. Warping of the mould can be detected on defective products, since deformation of the resin, including cracks, can occur in the products. These deformations can lead to the breakage of the glass fibres or carbon fibres in a plurality of glass fibre mats or carbon fibre mats located on top of one another. The wall thicknesses of the products and the distribution of the resin can thereby vary. Furthermore, structures can be formed by the arrangement of the glass fibre mats or carbon fibre mats, which form closed or covered hollow spaces in the final arrangement, which cause a stabilisation of the structure, allow vibrations and also dampen these in interaction with other components. It is therefore crucial that the fibres are not broken and can therefore absorb forces. During the forming process or pressing process, the dimensional stability of the pressing tools or the forming tool in relation to the resin with embedded GRP or CFRP ensures a fit over a temperature range of 0 to 420° C.

There is no warping of the mould or pressing tools. Due to the high wall thickness, curing of the resin takes a little longer. Nevertheless, to achieve effectiveness, the curing time should not be excessively long, which can be positively influenced by a temperature increase. However, this also means that the length expansion of the pressing tool or forming tool corresponds exactly to or is very similar to the length expansion of the glass fibre plastic or carbon fibre plastic.

It is also advantageous that displacements in the covering process of the open pressing tool with wafer-thin thermoplastic prepregs made of CFRP material are also prevented. Since a number of such wafer-thin (e.g. 0.04 mm to 0.72 mm) prepregs must be placed on top of one another in order to produce large components made of CFRP material, even the slightest displacements before or in the closing process of the press are sufficient to generate strong inhomogeneities with regard to the pressure distribution in the closed state of the press and thus prevent the product to be produced from being manufactured properly.

To manufacture the cast iron material according to the invention, the materials, e.g. scrap, crude iron, nickel, etc., are melted in a suitable furnace. An iron-silicon inoculant is added to the melt to stimulate germ production. This is also added in the casting basin if necessary. The casting temperature should then be adapted to the wall thickness of the workpiece to be produced and should lie within a range of approx. 1330° C. to approx. 1480° C. and higher, the thinner the wall of the workpiece to be produced.

The melt is then cast into a prepared casting mould, wherein the hollow space of the casting mould represents the resulting forming tool or the pressing tools, e.g. upper tool, lower tool, rollers, lining for press. After cooling, the casting is removed and further processed or prepared for use.

Normally, the casting must then be heated again to approx. 550° C. to approx. 650° C. and slowly cooled down to reduce the internal stresses. The casting can then be finished and installed as a lining in a forming tool or as a pressing tool, which in turn can be used for a reshaping process of thermoplastic semi-finished products, such as organo sheets or similar. Surprisingly, such a heat treatment, as mentioned above, is not required in the case of the cast iron material alloy according to the invention, in particular in the case of the application for the manufacture of large cast parts, for the production of precise component geometries, as is customary in the prior art.

Optical emission spectrometry and X-ray fluorescence can be used to determine the composition of the cast iron material. To determine the formation of spheroidal graphite, a metallographic grinding is produced, i.e. a material sample is taken, cut and an image is generated under a microscope, e.g. with a light microscope or a scanning electron microscope. Spheroidal graphite appears in a more circular form in the image, lamellar graphite appears in a more elongated form in the image.

The scanning electron microscope can have an attachment for measuring the X-ray fluorescence such that the elementary composition of the material sample in the penetration region of the X-rays can be determined at least integrally via the grinding. This allows weight percentages to be determined and compared with the claimed weight percentages.

The existence of the advantageous formation of a spheroidal graphite structure can also be delimited or verified non-destructively by means of a sound velocity measurement, e.g. compared to the existence of a steel casting structure having the disadvantages described above.

The casting resulting from the cast iron material is used with great advantage for the manufacture and/or lining of a forming tool or pressing tool.

Furthermore, the cast iron material is used with great advantage as a material for an upper pressing tool and lower pressing tool, wherein the pressing tool is operated in continuous or discrete operation.

A pressing tool, in particular for presses with large working surfaces, in which at least one length describing the working surface measures at least 2 m, 3 m, 5 m or even more than 8 m, can be manufactured particularly economically by using the present cast iron material and is excellently suitable for this due to its good damping behaviour and its extremely low thermal expansion behaviour.

It is furthermore of particular advantage if the cast iron material is used for the manufacture and/or lining of a pressing tool or a pressing die, wherein the exact chemical composition is adapted to the respective expansion behaviour of a material to be pressed, in particular a composite material to be pressed, and a process temperature provided for this purpose.

Finally, in a method for manufacturing and/or lining a forming tool or pressing tool in a casting process in which at least a part of the carbon present in the melt is precipitated to form a cast iron material, it is of great advantage if a material composition is used to obtain a cast iron material as described, since the present cast iron material exhibits particularly good damping behaviour and extremely low thermal expansion behaviour.

In connection with the subject matters of invention described above, reference is made to International Application No. PCT/EP2022/054333 filed Feb. 22, 2022, entitled “Pressing system and pressing tool for a press system, as well as method for manufacturing a workpiece”, the disclosure content of which is hereby incorporated by reference and made part of the present patent application in its entirety.

### DETAILED DESCRIPTION OF THE INVENTION

The invention is further described on the basis of advantageous exemplary embodiments:

In a first embodiment, in order to manufacture the cast iron material, 1 t of crude iron, 4 t of scrap, 3 t of nickel and 200 kg of a carbon carrier are added to an electric induction furnace with a capacity of 8 t and melted at 1500° C. After melting, the impurities formed on the surface of the melt are removed and a sample is taken for material analysis and, if necessary, correction of the melt composition. When the melt is released from the furnace, it is treated with the addition of a magnesium-containing pre-alloy to ensure spherical graphite formation. The melt is then filled into the prepared casting mould. The casting mould has a hollow space that corresponds to the shape of the lining of a forming tool or a pressing tool. After slow cooling in the mould to reduce residual stresses, the casting is emptied from the mould and cleaned. After mechanical processing, the casting is installed as a lining in a forming tool or a pressing tool.

The analysis of a material sample from the casting results in the following proportions (in percentage by weight) of a material composition:

| | |
|---|---|
| Carbon | 1.50% |
| Silicon | 1.50% |
| Manganese | 0.20% |
| Phosphorus | 0.025% |
| Copper | 0.10% |
| Nickel | 38.00% |
| Chrome | 0.10% |
| Magnesium | 0.065% |

remainder being iron and impurities.

In a second embodiment, 1.5 t of crude iron, 3.3 t of scrap, 3.2 t of nickel and 150 kg of a carbon carrier are added to an electric induction furnace for 8 t melt.

The analysis of a material sample from the casting results in the following proportions (in percentage by weight) of a material composition:

| | |
|---|---|
| Carbon | 1.70% |
| Silicon | 1.70% |
| Manganese | 0.25% |
| Phosphorus | 0.025% |
| Copper | 0.10% |
| Nickel | 40.00% |
| Chrome | 0.10% |
| Magnesium | 0.070% |

remainder being iron and impurities.

In a third embodiment, 2 t of crude iron, 2.6 t of scrap, 3.4 t of nickel and 100 kg of a carbon carrier are added to an electric induction furnace for 8 t melt.

The analysis of a material sample from the casting results in the following proportions (in percentage by weight) of a material composition:

| | |
|---|---|
| Carbon | 1.80% |
| Silicon | 1.70% |
| Manganese | 0.25% |
| Phosphorus | 0.025% |
| Copper | 0.10% |
| Nickel | 42.00% |
| Chrome | 0.10% |
| Magnesium | 0.080% |

remainder being iron and impurities.

In a fourth embodiment, 3.2 t of crude iron, 1.8 t of scrap, 3 t of nickel and 280 kg of a carbon carrier are added to an electric induction furnace for 8 t melt.

The analysis of a material sample from the casting results in the following proportions (in percentage by weight) of a material composition:

| | |
|---|---|
| Carbon | 2.55% |
| Silicon | 1.8% |
| Manganese | 0.30% |
| Phosphorus | 0.02% |
| Copper | 0.08% |
| Nickel | 37.75% |
| Chrome | 0.20% |
| Magnesium | 0.08% |

remainder being iron and impurities.

In a fifth embodiment, 3 t of crude iron, 1.9 t of scrap, 3.1 t of nickel and 220 kg of a carbon carrier are added to an electric induction furnace for 8 t melt.

The analysis of a material sample from the casting results in the following proportions (in percentage by weight) of a material composition:

| | |
|---|---|
| Carbon | 2.06% |
| Silicon | 1.65% |
| Manganese | 0.25% |
| Phosphorus | 0.02% |
| Copper | 0.10% |
| Nickel | 38.75% |
| Chrome | 0.15% |
| Magnesium | 0.10% |

remainder being iron and impurities.

In a sixth embodiment, 3.2 t of crude iron, 1.75 t of scrap, 3.05 t of nickel and 350 kg of a carbon carrier are added to an electric induction furnace for 8 t melt.

The analysis of a material sample from the casting results in the following proportions (in percentage by weight) of a material composition:

| | |
|---|---|
| Carbon | 3.00% |
| Silicon | 1.95% |
| Manganese | 0.25% |
| Phosphorus | 0.02% |
| Copper | 0.10% |
| Nickel | 38.05% |
| Chrome | 0.15% |
| Magnesium | 0.10% |

remainder being iron and impurities.

The second to sixth embodiment, for example the fourth to sixth embodiment, are also preferably produced under the circumstances described for the first embodiment. It goes without saying that the capacity of 8 t is understood to mean the payload of the electric induction furnace assumed in the embodiments, not the maximum manufacturable weight.

The invention is not limited to the exemplary embodiments presented and described, but can be reasonably adapted and/or supplemented within the protected scope defined by the independent claims without departing from the scope of the invention. In particular, depending on the application case, a number of intermediate ranges of the stated alloy proportions are conceivable and sensible for various further embodiments. In particular, the nickel content for special embodiments can assume narrow intermediate ranges without departing from the teaching of the invention. Of course, the exemplary embodiments mentioned can also be scaled to other total quantities.

The invention is not limited to the exemplary embodiments presented and described, but also includes all embodiments with the same effect within the meaning of the invention. It is expressly emphasized that the exemplary embodiments are not limited to all features in combination; rather, each individual partial feature can also have an inventive significance in isolation from all other partial features. Furthermore, the invention is so far also not limited to the combination of features defined in claim 1, but can also be defined by any other combination of certain features of all individual features disclosed as a whole. This means that practically every individual feature of claim 1 can be omitted or replaced by at least one individual feature disclosed elsewhere in the application.

1. A cast iron material, which comprises at least the proportions in percentage by weight as elements or compounds of:
Carbon in the range of approx. 1.0% to 4.0%,
Silicon in the range of approx. 1.0% to 5.0%,
Manganese in the range of approx. 0.1% to 1.5%,
Nickel in the range of approx. 36.5% to 48.0%,
Chromium in the range of approx. 0.01% to 0.25%,
Phosphorus up to approx. 0.08%,
Copper up to approx. 0.5%,
Magnesium up to approx. 0.15%,
with the remainder being iron and unavoidable impurities.

2. The cast iron material according to claim 1, wherein in addition to the listed elements, impurities are contained in the cast iron material in the range of approx. 0.0% to 5.0%, preferably 0.0% to 1.0%, quite preferably 0.0% to 0.5%.

3. The cast iron material according to claim 1, wherein the proportion of carbon is in the range of approx. 1.0% to 3.2%, preferably of approx. 1.0% to 2.5%, particularly preferred of approx. 1.3% to 2.0%.

4. The cast iron material according to claim 1, wherein the proportion of carbon is in the range of approx. 2.0% to 4.0%, preferably of approx. 2.06% to 4.0%, particularly preferably of approx. 2.2% to 4.0%.

5. The cast iron material according to claim 1, wherein the proportion of nickel is in the range of approx. 37.0% to 48.0%, preferably of approx. 37.0% to 45.0%, particularly preferably of approx. 37.5 to 43.0%, even more preferably of approx. 40.1% to 43.0%.

6. The cast iron material according to claim 1, wherein it has a proportion of magnesium in the range of approx. 0.020% to 0.150%, preferably of approx. 0.040% to 0.100%, particularly preferably of approx. 0.065% to 0.090%.

7. The cast iron material according to claim 1, wherein the proportion of silicon is in the range of approx. 1.1% to 5.0%, preferably of approx. 1.15% to 5.0%, particularly preferably of approx. 1.3% to 5.0%.

8. The cast iron material according to claim 1, wherein the proportion of niobium is below 0.33%, in particular below 0.22%, quite in particular below 0.11%.

9. The cast iron material according to claim 1, wherein the proportion of cobalt is below 4.0%, in particular below 2.75%, quite in particular between 0.005% and 1.5%.

10. The cast iron material according to claim 1, wherein the proportion of aluminium is below 1.0%, in particular below 0.75%, quite in particular between 0.001% and 0.500%.

11. The cast iron material according to claim 1, wherein the carbon is present at least predominantly as spheroidal graphite.

12. A method for manufacturing and/or lining a forming tool or pressing tool, comprising the step of using a cast iron material according to claim 1, wherein the casting resulting from the cast iron material is used to manufacture and/or line a forming tool or pressing tool.

13. A method for operating a pressing tool in a continuous or discrete operation, comprising the step of using a cast iron material according to claim 1, wherein the cast iron material is used as material for an upper pressing tool and lower pressing tool in a press, wherein the pressing tool is operated in continuous or discrete operation.

14. A method for the manufacture and/or lining of a pressing tool or a pressing die, comprising the step of using a cast iron material according to claim 1, wherein the exact chemical composition is adapted to the respective expansion behaviour of a material to be pressed, in particular a composite material to be pressed, and a process temperature provided for this purpose.

15. A method for manufacturing and/or lining a forming tool or pressing tool in a casting process in which at least a part of the carbon present in the melt is precipitated to form a cast iron material, wherein a material composition is used to achieve a cast iron material according to claim 1.
